(19) United States
(12) Patent Application Publication
(10) Pub. No.: US 2021/0334120 A1
(43) Pub. Date: Oct. 28, 2021

(54) Computer Back Control System and Method

(71) Applicant: Actions Microelectronics Co., Ltd., Shenzhen (CN)

(72) Inventor: Jian-Chang Cheng, New Taipei City (TW)

(21) Appl. No.: 16/325,237

(22) PCT Filed: Jul. 31, 2018
(86) PCT No.: PCT/CN2018/097779

§ 371 Date: Feb. 13, 2019

(30) Foreign Application Priority Data
Jul. 9, 2018 (CN) 201810746565.2

(51) Int. Cl. G06F 9/451; G06F 13/42; G06F 3/14; H04W 48/20; H04W 76/10

(52) U.S. Cl. CPC G06F 9/452; G06F 13/4282; G06F 2213/0042; H04W 48/20; H04W 76/10; G06F 3/1454

(57) ABSTRACT

The present invention relates to a computer back control system and method. The system includes a first communication device and at least one second communication device. The first communication device includes a first interface configured to receive control information, a second interface configured to send interface information, and a first wireless transceiving module configured to send the control information and receive the interface information; the second communication device includes a second wireless transceiving module configured to receive the control information from the first wireless transceiving module, and send the interface information to the first wireless transceiving module, a third interface configured to send the control information to the computer, and a fourth interface configured to receive the currently displayed interface information from the computer. Plug-and-play is achieved; the situation that some actions cannot be simulated is avoided; and the real-time performance of back control is greatly improved.

### TECHNICAL FIELD

The present invention relates to the field of information transmission, and in particular, to a computer back control system and method.

### BACKGROUND

In many application scenarios, for example, when a remote conference is opened, a user is often required to perform back control on a remote computer. In the prior art, in conjunction with a back control system of a computer shown in FIG. 1, an external human interface device (HID), such as a mouse, a display screen, and a touch screen, is connected to a wireless transceiving box through a universal serial bus (USB). When the user inputs control information through the mouse or the touch screen, the wireless transceiving box can obtain the control information through the USB, and parse the received USB data packet to obtain coordinate and motion information of the mouse or the touch screen. Then, the wireless transceiving box transmits the parsed coordinate and motion information to a remote personal computer (PC) through the network. Application software is installed on the PC. The application software implements the following two functions through an application program interface (API) provided by an operating system (OS): 1. A function of simulating the action of the mouse or the touch screen according to the coordinate and motion information, namely the back control function; 2. A function of transmitting the interface currently displayed by the PC to the display screen or the touch screen through the wireless transceiving box, namely the mirror function; and through the function, the back control of the remote PC by a user is achieved.

However, the above computer back control system has the following drawbacks:
1. The application software must be installed on the PC, and since the OS type/version on each PC is not identical, different application software needs to be developed for different OS types/versions;
2. The user's back control of the PC is heavily dependent on the function of the application software, so that it is possible that some actions cannot be simulated. For example, the user can operate a left button, a right button, and a middle wheel of the mouse. However, when the installed application software sets the API parameters of the OS, only the parameter settings of the left button and the right button are performed, but no parameter setting of the middle wheel operation is performed, so the user cannot achieve the action simulation on the operation of the middle wheel;
3. The control information needs to be processed by the wireless transceiving box and processed by the application software on the PC, which is not good in real-time performance of the back control.

### SUMMARY

Against the technical problem to be solved, and against the above-mentioned drawbacks in the prior art, the present invention provide a computer back control system and method.

The technical solution adopted by the present invention to solve the technical problem is to construct a computer back control system that is configured to enable a user to perform back control of a remote computer through an HID. The computer back control system includes a first communication device and at least one second communication device; where,
the first communication device includes:
a first interface, configured to receive control information input by a user from the HID;
a second interface, configured to send interface information to the HID; and
a first wireless transceiving module, configured to send the control information and receive the interface information;
the second communication device includes:
a second wireless transceiving module, configured to receive, after being in pair connection with the first communication device, the control information from the first wireless transceiving module, and send the interface information to the first wireless transceiving module;
a third interface, configured to send the control information to the computer; and
a fourth interface, configured to receive the currently displayed interface information from the computer.

Preferably, the first interface and the third interface are USB ports respectively.

Preferably, the second interface and the fourth interface are HDMIs respectively.

The invention also constructs a computer back control method that is used to enable a user to perform back control of a remote computer through an HID, where a first communication device performs the following steps:
performing pair connection with a second communication device;
receiving control information input by a user from the HID, and sending the control information to the second communication device; and
receiving currently displayed interface information from the second communication device, and sending the interface information to the HID.

Preferably, the receiving control information input by a user from the HID includes:
receiving control information input by a user from the HID through a USB.

Preferably, the sending the interface information to the HID includes:

Sending the interface information to the HID through an HDMI.

The invention also constructs a computer back control method that is used to enable a user to perform back control of a remote computer through an HID, where a second communication device performs the following steps:
performing pair connection with a first communication device;
receiving control information input by a user from the first communication device, and sending the control information to a computer; and
receiving currently displayed interface information from the computer, and sending the interface information to the first communication device.

Preferably, the sending the control information to the computer includes: sending the control information to the computer through a USB.

Preferably, the receiving currently displayed interface information from the computer includes:
receiving currently displayed interface information from the computer through an HDMI.

Preferably, the performing pair connection with a first communication device includes:
receiving a pairing document, the pairing document including a service set identifier (SSID) of the first communication device;
performing WiFi scanning and matching the scanning result with the SSID in the pairing document; and
if the matching is successful, accessing an AP of the first communication device to complete the pair connection.

Preferably, the pairing document further includes identification information and/or password information of the first communication device; besides, the accessing an AP of the first communication device includes:
determining, according to the scanning result, whether the identification information and/or the password information in the pairing document match; and
if the matching is successful, accessing the AP of the first communication device.

Preferably, the performing pair connection with a first communication device includes:
performing pair connection with the first communication device through Bluetooth.

The technical solution of the present invention has the following beneficial effects:
1. It is not necessary to install any application software on the computer, and the plug-and-play is truly achieved;
2. Since the control information received by the original HID is transferred to the computer as it is, all the action information can be simulated, and the situation that some actions cannot be simulated is avoided;
3. The control information is not processed, the raw data obtained from the HID is directly sent to the operating system of the computer, and the real-time performance of the back control is greatly improved.

### BRIEF DESCRIPTION OF DRAWINGS

In order to explain embodiments of the present invention more clearly, the accompanying drawings used in the description of the embodiments will be briefly introduced below. Apparently, the accompanying drawings in the following description are only some embodiments of the present invention, and those of ordinary skills in the art can also obtain other accompanying drawings according to these accompanying drawings without any creative work. In the accompanying drawings:

FIG. 1 is a structural diagram of Embodiment 1 of a computer back control system, an HID, and a computer of the present invention;

FIG. 2 is a logical structural diagram of Embodiment 2 of a computer back control system of the present invention;

FIG. 3 is a flow chart of Embodiment 1 of a computer back control method of the present invention; and

FIG. 4 is a flow chart of Embodiment 2 of a computer back control method of the present invention.

### DESCRIPTION OF EMBODIMENTS

The technical solutions in the embodiments of the present invention are clearly and completely described in the following with reference to the accompanying drawings in the embodiments of the present invention. Apparently, the described embodiments are only some embodiments of the present invention rather than all embodiments. All other embodiments obtained by those of ordinary skills in the art based on the embodiments of the present invention without creative efforts are within the protective scope of the present invention.

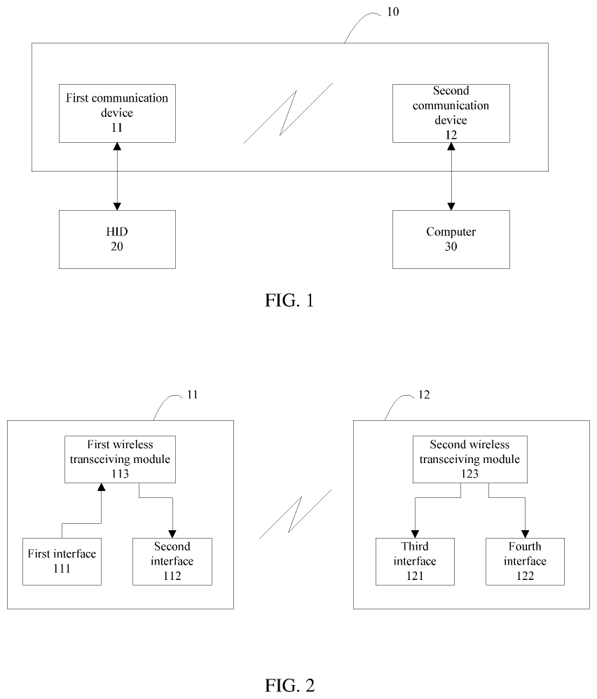

FIG. 1 is a structural diagram of Embodiment 1 of a computer back control system, an HID, and a computer of the present invention. In this embodiment, a back control system 10 is used to enable a user to perform back control of a remote computer 30 through an HID 20; moreover, the computer control system 10 includes a first communication device 11 and a second communication device 12. It should be understood that in other embodiments, the number of second communication devices 12 may be multiple.

In conjunction with FIG. 2, the first communication device 11 includes a first interface 111, a second interface 112, and a first wireless transceiving module 113; and the second communication device 12 includes a third interface 121, a fourth interface 122, and a second wireless transceiving module 123. Moreover, the first interface 111 is configured to receive control information input by a user from the HID 20, where the control information includes, for example, operation information such as left click, right click, and scroll of the mouse, or includes operation information such as clicks on the touch panel, sliding and long press; the second interface 112 is configured to send interface information to the HID 20; the first wireless transceiving module 113 is configured to send the control information and receive the interface information. The third interface 121 is configured to send the control information to the computer 30; and the fourth interface 122 is configured to receive the currently displayed interface information from the computer 30; the second wireless transceiving module 123 is configured to receive, after being in pair connection with the first communication device 11, the control information from the first wireless transceiving module 113, and send the interface information to the first wireless transceiving module 113. It should be noted that when the HID 20 is a touch screen, the first interface 111 and the second interface 112 of the first communication device 11 are connected to the touch screen; when the HID 20 includes a mouse and a display screen, the first interface 111 of the first communication device 11 is connected to the mouse, and the second interface 112 of the first communication device 11 is connected to the display screen.

When the computer back control system of this embodiment is used, first, the HID 20 is connected to the first communication device 11 through the first interface 111 and the second interface 112, and the second communication device 12 is connected to the computer 30 through the third interface 121 and the fourth interface 122. After the first communication device 11 and the second communication device 12 are in pair connection, the user can input control information through the HID 20, and then the first communication device 11 can receive the control information through the first interface 111, and then through the network, the control information is sent to the second communication device 12 as it is; the second communication device 12 inputs the control information to the OS of the computer 30 through the third interface 121, thereby triggering the back control function. At the same time, the interface information currently displayed on the computer 30 is also transmitted to the second communication device 12 through the fourth interface 122. After receiving the interface information, the second communication device 12 sends the interface information to the first communication device 11 through the network, and then the first communication device 11 transmits the interface information through the second interface 112 to the HID 20 for display to implement the mirror function. In other words, when the back control function is implemented, since the control information is not subjected to any processing during the entire transmission process, after receiving the control information from the second communication device 12, the computer 30 considers that the second communication device 12 is an HID which is the same as the HID 20 connected to the first communication device 11.

The technical solution of this embodiment has the following beneficial effects:
1. It is not necessary to install any application software on the computer 30, and the plug-and-play is truly achieved;
2. Since the control information received by the original HID 20 is transferred to the computer 30 as it is, all the action information can be simulated, and the situation that some actions cannot be simulated is avoided;
3. The control information is not processed, and the raw data obtained from the HID 20 is directly sent to the operating system of the computer 30, and the real-time performance of the back control is greatly improved.

In a preferred embodiment, the first interface 111 and the third interface 121 are USB ports respectively.

In a preferred embodiment, the second interface 112 and the fourth interface 122 are HDMIs respectively.

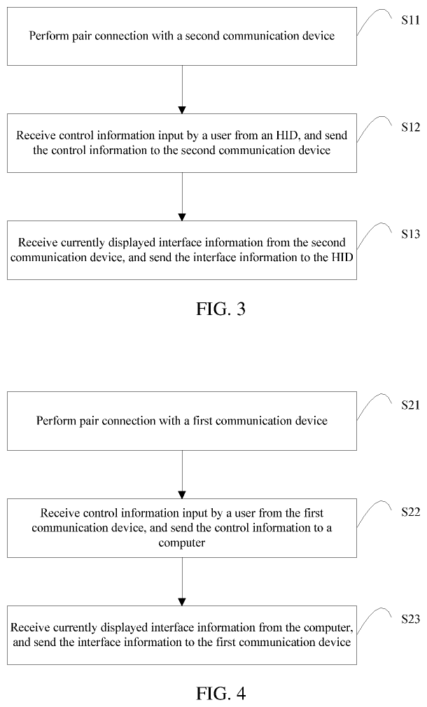

FIG. 3 is a flow chart of Embodiment 1 of a computer back control method of the present invention. The back control method of this embodiment is used to enable a user to perform back control of a remote computer through an HID. Moreover, it should be noted that the first communication device and the second communication device appear in pairs, or the first communication device and the second communication devices have a one-to-many relationship. The first communication device is disposed on the user side, and the second communication device is disposed on the computer side. The control method of this embodiment is applied to the first communication device, and specifically includes the following steps:

Step S11. Perform pair connection with a second communication device.

Step S12. Receive control information input by a user from the HID, and send the control information to the second communication device.

Step S13. Receive currently displayed interface information from the second communication device, and send the interface information to the HID. It should be noted that step S12 and step S13 have no obvious timing relationship and can be executed simultaneously.

In this embodiment, after the first communication device is in pair connection with the second communication device, the user can input the control information through the HID, the first communication device can receive the control information, and then the control information is sent to the second communication device through the network as it is. The second communication device then sends the control information to the OS of the computer, thereby triggering the back control function. At the same time, the interface information currently displayed on the computer is also transmitted to the second communication device. After receiving the interface information, the second communication device sends the interface information to the first communication device through the network, and then the first communication device sends the interface information to the HID for display to implement the mirror function. In other words, when the back control function is implemented, since the control information is not subjected to any processing during the entire transmission process, after receiving the control information from the second communication device, the computer considers that the second communication device is an HID which is the same as the HID connected to the first communication device.

The technical solution of this embodiment has the following beneficial effects:
1. It is not necessary to install any application software on the computer, and the plug-and-play is truly achieved;
2. Since the control information received by the original HID is transferred to the computer as it is, all the action information can be simulated, and the situation that some actions cannot be simulated is avoided;
3. The control information is not processed, the raw data obtained from the HID is directly sent to the operating system of the computer, and the real-time performance of the back control is greatly improved.

Preferably, in step S12, the control information input by the user is received from the HID through a USB; and in step S13, the interface information is sent to the HID through an HDMI.

FIG. 4 is a flow chart of Embodiment 2 of a computer back control method of the present invention. The back control method of this embodiment is used to enable a user to perform back control of a remote computer through an HID. Moreover, it should be noted that the first communication device and the second communication device appear in pairs, or the first communication device and the second communication devices have a one-to-many relationship. The first communication device is disposed on the user side, and the second communication device is disposed on the computer side. The control method of this embodiment is applied to the second communication device, and specifically includes the following steps:

Step S21. Perform pair connection with a first communication device.

Step S22. Receive control information input by a user from the first communication device, and send the control information to a computer.

Step S23. Receive currently displayed interface information from the computer, and send the interface information to the first communication device. It should be noted that step S22 and step S23 have no obvious timing relationship and can be executed simultaneously.

In this embodiment, after the second communication device is in pair connection with the first communication device, the user can input the control information through the HID, the first communication device can receive the control information, and then the control information is sent to the second communication device through the network as it is. The second communication device then sends the control information to the OS of the computer, thereby triggering the back control function. At the same time, the interface information currently displayed on the computer is also transmitted to the second communication device. After receiving the interface information, the second communication device sends the interface information to the first communication device through the network, and then the first communication device sends the interface information to the HID for display to implement the mirror function. In other words, when the back control function is implemented, since the control information is not subjected to any processing during the entire transmission process, after receiving the control information from the second communication device, the computer considers that the second communication device is an HID which is the same as the HID connected to the first communication device.

The technical solution of this embodiment has the following beneficial effects:

1. It is not necessary to install any application software on the computer, and the plug-and-play is truly achieved;

2. Since the control information received by the original HID is transferred to the computer as it is, all the action information can be simulated, and the situation that some actions cannot be simulated is avoided;

3. The control information is not processed, the raw data obtained from the HID is directly sent to the operating system of the computer, and the real-time performance of the back control is greatly improved.

Preferably, in step S22, the control information is sent to the computer through a USB; and in step S23, the currently displayed interface information is received from the computer through an HDMI.

In an alternative embodiment, step S21 may include the following steps:
receiving a pairing document, the pairing document including a service set identifier (SSID) of the first communication device;
performing WiFi scanning and matching the scanning result with the SSID in the pairing document; and
if the matching is successful, accessing an AP of the first communication device to complete the pair connection.

In this embodiment, the second communication device obtains the SSID information of the first communication device by receiving the pairing document. Moreover, at startup, WiFi scanning is performed, and the scanning result is compared with the SSID in the pairing document. If the match is successful, the AP of the first communication device is accessed to complete the pairing.

Further, the pairing document includes identification information and/or password information of the first communication device, and when the SSID is successfully matched, determining whether the identification information and/or the password information in the pairing document match according to the scanning result, and only when the matching of the identification information and/or the password information is successful, is the AP of the first communication device accessed.

In a specific embodiment, the pairing document can be received through a USB cable. Specifically, the USB cable on the second communication device is directly connected to a USB port of the first communication device. After the first communication device is powered on, whether the connected USB device is the second communication device is determined first, and if so, a pairing document is copied to the connected second communication device, and the pairing document includes device information of the first communication device, specifically including: category, unique identifier (uuid), device name, SSID, wireless encryption mechanism, encrypted online password, and the like. The second communication device searches for, by means of the pairing document, whether there is a first communication device with the same pairing document in the vicinity through the wireless network at the time of startup, thereby completing the pairing of the first communication device and the second communication device. Moreover, when an indicator on the second communication device or the “Pairing” displayed on an on screen display (OSD) image of the first communication device is turned to OK, it indicates that the pairing is completed.

In a specific embodiment, the pairing document can be received through a terminal device. Specifically, it should be noted first that an embedded webpage of the first communication device has a function of downloading the pairing document, and an embedded webpage of the second communication device has a function of uploading the pairing document. When the pairing is required, the pairing document is downloaded from the first communication device by manipulating the terminal device, then the AP of the second communication device is turned on, and the AP of the second communication device is connected through the terminal device to open the embedded webpage of the second communication device, enter the pairing document upload interface, click on the upload control (upload) to upload the pairing document that has been downloaded well in advance.

In a specific embodiment, the pairing document can also be received through a USB flash disk. Specifically, the USB flash disk is inserted into the first communication device, and the function key is pressed. At this time, the pairing document stored in advance in the first communication device is copied into the USB flash disk. Then, the USB flash disk is inserted into the second communication device, and the second communication device is set as a slave device. At this time, the pairing document stored in the USB flash disk is also copied into the second communication device. When the pairing is completed, the indicator of the first communication device will turn white.

In a specific embodiment, the pairing document can also be received through a USB flash disk. Specifically, the USB flash disk is inserted into the USB port of the terminal device (for example, a PC). After the PC is connected to the first communication device, the pairing document can be downloaded to the USB flash disk through the embedded webpage of the first communication device. Then, the USB flash disk is inserted into the second communication device, and at this time, the second communication device downloads the pairing document from the USB flash disk, thereby completing the pairing.

Certainly, in other embodiments, pairing can also be performed in the following manner: first, the embedded webpage is also included in the second communication device. During pairing, the user can connect the second communication device to other terminal devices (such as a PC, a smart phone, and a PAD) through an Ethernet network or a wireless network, and input an SSID of the first communication device in the second communication device through the terminal device. If necessary, enter a password again to access the second communication device to the AP of the first communication device to complete the pairing.

The above several embodiments are all paired by WiFi, and in other embodiments, the pairing can also be performed by Bluetooth. Specifically, press the pairing button on the first communication device and enter the Bluetooth pairing mode, press the main+side button on the second communication device and enter the pairing mode, and then the second communication device scans the first communication device nearby for Bluetooth connectivity.

The above descriptions are only the preferred embodiments of the present invention, and are not intended to limit the present invention, and for those skilled in the art, various modifications and changes can be made to the present invention. Any tampering, equivalent substitution, improvement, etc., within the spirit and scope of the present invention should be included within the scope of the claims of the present invention.

What is claimed is:

1. A computer back control system, configured to enable a user to perform back control of a remote computer through an HID, comprising a first communication device and at least one second communication device; wherein,
the first communication device comprises:
a first interface, configured to receive control information input by a user from the HID;
a second interface, configured to send interface information to the HID; and
a first wireless transceiving module, configured to send the control information and receive the interface information;
the second communication device comprises:
a second wireless transceiving module, configured to receive, after being in pair connection with the first communication device, the control information from the first wireless transceiving module, and send the interface information to the first wireless transceiving module;
a third interface, configured to send the control information to the computer; and
a fourth interface, configured to receive the currently displayed interface information from the computer.

2. The computer back control system according to claim 1, wherein the first interface and the third interface are USB ports respectively.

3. The computer back control system according to claim 1, wherein the second interface and the fourth interface are HDMIs respectively.

4. A computer back control method, used to enable a user to perform back control of a remote computer through an HID, wherein a first communication device performs the following steps:
performing pair connection with a second communication device;
receiving control information input by a user from the HID, and sending the control information to the second communication device; and
receiving currently displayed interface information from the second communication device, and sending the interface information to the HID.

5. The computer back control method according to claim 4, wherein the receiving control information input by a user from the HID comprises:
receiving control information input by a user from the HID through a USB.

6. The computer back control method according to claim 4, wherein the sending the interface information to the HID comprises:
sending the interface information to the HID through an HDMI.

7. A computer back control method, used to enable a user to perform back control of a remote computer through an HID, wherein a second communication device performs the following steps:
performing pair connection with a first communication device;
receiving control information input by a user from the first communication device, and sending the control information to a computer; and
receiving currently displayed interface information from the computer, and sending the interface information to the first communication device.

8. The computer back control method according to claim 7, wherein the sending the control information to a computer comprises:
sending the control information to the computer through a USB.

9. The computer back control method according to claim 7, wherein the receiving currently displayed interface information from the computer comprises:
receiving currently displayed interface information from the computer through an HDMI.

10. The computer back control method according to claim 7, wherein the performing pair connection with a first communication device comprises:
receiving a pairing document, the pairing document comprising a service set identifier (SSID) of the first communication device;
performing WiFi scanning and matching the scanning result with the SSID in the pairing document; and
if the matching is successful, accessing an AP of the first communication device to complete the pair connection.

11. The computer back control method according to claim 10, wherein the pairing document further comprises identification information and/or password information of the first communication device; besides, the accessing an AP of the first communication device comprises:
determining, according to the scanning result, whether the identification information and/or the password information in the pairing document match; and
if the matching is successful, accessing the AP of the first communication device.

12. The computer back control method according to claim 7, wherein the performing pair connection with a first communication device comprises:
performing pair connection with the first communication device through Bluetooth.
